(19) United States
(12) Patent Application Publication
(10) Pub. No.: US 2024/0410692 A1
(43) Pub. Date: Dec. 12, 2024

(54) ROTATIONAL ANGLE SENSOR UNIT AND ANTI-ROTATION DEVICE FOR A ROTATIONAL ANGLE SENSOR UNIT

(71) Applicant: HELLA GmbH & Co. KGaA, Lippstadt (DE)

(72) Inventors: Andreas BOETTCHER, Lippstadt (DE); Keramettin SEVEN, Lippstadt (DE)

(73) Assignee: HELLA GmbH & Co. KGaA, Lippstadt (DE)

(21) Appl. No.: 18/808,071

(22) Filed: Aug. 18, 2024

Related U.S. Application Data
(63) Continuation of application No. PCT/EP2023/052396, filed on Feb. 1, 2023.

(30) Foreign Application Priority Data
Feb. 17, 2022 (DE) 10 2022 103 722.3

(51) Int. Cl. G01B 21/22

(52) U.S. Cl. CPC G01B 21/22

(57) ABSTRACT

A rotational angle sensor unit for determining a rotational angle between a rotor and a stator, having a housing which defines a housing volume. The rotor is rotatably mounted in the housing volume. A printed circuit board has the at least one stator secured thereto. An anti-rotation device with a main part and a plastic spring prevents a rotation of the housing relative to a stationary mounting body when the housing is positioned in a mounting volume of the mounting body. The plastic spring has a plastic spring inner face facing the main part and a plastic spring outer face facing away from the main part. The plastic spring has a wall thickness ranging between 1.8 mm and 2.5 mm between the plastic spring inner face and the plastic spring outer face. An anti-rotation device for a rotational angle sensor unit is also provided.

This nonprovisional application is a continuation of International Application No. PCT/EP2023/052396, which was filed on Feb. 1, 2023, and which claims priority to German Patent Application No. 10 2022 103 722.3, which was filed in Germany on Feb. 17, 2022, and which are both herein incorporated by reference.

### BACKGROUND OF THE INVENTION

### Field of the Invention

The present invention relates to a rotational angle sensor unit for determining a rotational angle between a rotor and a stator, as well as an anti-rotation device for a rotational angle sensor unit.

### Description of the Background Art

Inductive torque and/or rotational angle sensor units are generally known in the prior art. They are used, for example, in motor vehicles to ascertain torques such as steering moments. This is increasingly necessary because more and more electromotive servo devices are used for power assisted steering. The latter require a variable of the steering moment for control. Steering moments are detectable in a steering column by a shaft and, in particular, by a torsion bar in difference angles and calculated therefrom. For this purpose, the rotations at the ends of the torsion bar are determined as signals with the aid of a suitable arrangement and supplied to evaluation units. The difference angle effectuated by the torsion may be determined independently of a position of the steering wheel. It is furthermore important to know the position of the steering wheel, for example for driver assistance systems. A steering lock of the steering wheel is determined for this purpose with the aid of a rotational angle sensor unit.

Numerous further variants of known rotational angle sensor units are described in EP 2 870 033 B1, which corresponds to US 2015/0168140, which is incorporated herein by reference.

It is known to fasten one or multiple rotors of a rotational angle sensor unit to the steering column, while stators are arranged on a printed circuit board in a housing, which is rotatably fixedly supported in the motor vehicle. To achieve the desired torsional strength, for example, a connecting component formed on the housing is guided in a groove as an anti-rotation device, the groove being introduced into a bearing body fixedly installed in the vehicle. To compensate for manufacturing tolerances, play, and wear, a plastic spring is formed on the connecting component or the anti-rotation device from the same material as the housing. In generic specific embodiments, this results in the disadvantage that the spring force decreases at higher temperatures, and the housing is thus subjected to a rotational play. The accuracy of the sensor is negatively influenced thereby. Comparable means for the described establishment of a torsional strength are described in EP 2 011 697 A2, which corresponds to U.S. Pat. No. 7,452,224, and in DE 10 2007 055 392 A1 for a winding strip.

To take into account the problems described above, it is proposed in EP 2 870 054 B1, which is incorporated herein by reference, to support a plastic spring of an anti-rotation device by means of a metal spring. This makes it possible to reliably ensure a sufficiently high pressure of the plastic spring onto the bearing body at high temperatures at which the plastic of the plastic spring softens, so that the latter no longer has the full tensioning force. In other words, with the aid of the metal spring, a sufficiently high tension of the connecting component may always be ensured, so that the housing is rotatably positioned in the bearing body without play and in an anti-rotational manner. By adding a metal spring to the plastic spring, however, the degree of complexity of the rotational angle sensor unit is also increased, compared to previously known approaches.

### SUMMARY OF THE INVENTION

It is therefore an object of the present invention to at least partially take into account the problems described above. In particular, the object of the present invention is to provide an anti-rotation device for a rotational angle sensor unit, which is without play under as many operating conditions as possible, using simple means.

The above object is achieved by a rotational angle sensor unit, as well as the anti-rotation device. Features which are described in connection with the rotational angle sensor unit also apply, of course, in connection with the anti-rotation device according to the invention and vice versa in each case, so that reference always is or may be made interchangeably with respect to the disclosure of the individual aspects of the invention.

According to a first aspect of the present invention, a rotational angle sensor unit is proposed for determining a rotational angle between a rotor and a stator. The rotational angle sensor unit includes a housing, which defines a housing volume, the rotor, which is rotatably supported in the housing volume, and the stator. The rotational angle sensor unit further includes a printed circuit board to which the at least one stator is fastened, and an anti-rotation device. The anti-rotation device comprises a base body and a plastic spring for securing against a rotation of the housing relative to a stationary bearing body when the housing is positioned in a bearing volume of the bearing body. The plastic spring has a plastic spring inner face facing the base body and a plastic spring outer face facing away from the base body, the plastic spring having a wall thickness in a range between 1.8 mm and 2.5 mm between the plastic spring inner face and the plastic spring outer face, i.e., in particular in a direct direction and/or the shortest distance from the plastic spring inner face and the plastic spring outer face.

A core of the present invention is first the finding that, due to a special geometry of the plastic spring, it is possible to dispense with the metal spring, which up to now has been found to be necessary, and still achieve the desired stability in the plastic spring over a high temperature range as well as in many different operating states. In trials within the scope of the present invention, in particular, the proposed wall thickness in the range between 1.8 mm and 2.5 mm has shown to be advantageous in this regard. It was possible to achieve particularly good results with a wall thickness in a range between 1.8 mm and 2.2 mm, in particular with a wall thickness in a range between 1.8 mm and 2 mm. In trials within the scope of the invention, it has surprisingly been shown that only a few tenths of a millimeter account for the crucial difference between a functioning plastic spring and one which does not function as desired.

The plastic spring has the proposed wall thickness or the range, preferably over its entire length and/or height, the wall thickness of the plastic spring being able to change over the length of the plastic spring. The plastic spring may have a connecting section, to which the plastic spring is connected to the base body in a materially bonded manner. The plastic spring may furthermore have an end-side spring head with an end face and an intermediate section between the connecting section and the spring head. The plastic spring may additionally have a transitional section between the intermediate section and the spring head. The wall thickness may be smaller in the transitional section than in the spring head and/or in the intermediate section. In other words, the wall thickness of the plastic spring may decrease in the intermediate section and/or in the connecting section in the direction of the spring head and increase again in the spring head. The areas of the plastic spring subjected to greater mechanical stress may thus achieve a greater stability, while a material and weight saving may be achieved in the areas subjected to less stress. On the whole, a good compromise may thus be achieved between as little material as possible and nevertheless a high stability.

The plastic spring may be designed in the form of a spring arm, in particular in the form of a monolithic spring arm. The plastic spring is therefore preferably fastened to the base body at only one point. In particular, the base body and the spring arm are designed as an integral and/or monolithically interconnected unit.

In addition to the one rotor, the rotational angle sensor unit may include at least one further rotor, and in addition to the one stator, the rotational angle sensor unit may include at least one further stator.

A printed circuit board may be a circuit board or a generic PCB. In addition to the at least one stator, further electrical and/or electronic components are preferably fastened to the printed circuit board. The housing may be an open housing shell, which may be closed by a cover. If the housing is closed, it still has, of course, at least one overall housing through-opening, through which a shaft and the rotor may extend.

The rotor may be a structural unit including a rotor sleeve, a crown-shaped conductor section, and a connector for connecting the rotor rim with the rotor sleeve. However, the conductor section on the end face may also be or become formed integrally or as a single piece together with the rotor sleeve. The rotational angle may be the absolute value of a relative rotation between the rotor and the stator. The relative rotation or the rotational angle may be ascertained with the aid of the rotor and the stator and/or with the aid of at least one further rotor and/or with the aid of at least one further stator.

The plastic spring can be connected to the base body in a materially bonded manner in a connecting section and has an inner radius of curvature in a range between 0.5 mm and 1 mm in the connecting section. An outer radius of curvature may have a value which results from the inner radius of curvature and the wall thickness described above, the circular paths of the inner radius of curvature and the outer radius of curvature extending coaxially to each other or approximately coaxially to each other. The proposed wall thickness in combination with the proposed inner radius of curvature results in an advantageous flexibility as well as stability of the plastic spring. The radius of curvature preferably extends away from the base body over a range between 30° and 60°, in particular approximately 45°, up to the beginning of the intermediate section, at which the inner and/or outer radii of curvature or the associated connecting section end(s).

It may be further advantageous if, in the rotational angle sensor unit, the plastic spring can have a base body outer face facing the plastic spring inner face, an angle between the plastic spring inner face and the base body outer face being in a range between 7° and 11° in an unloaded state of the plastic spring. As a result, the plastic spring may provide the desired flexibility and pretensioning for the purpose of anti-rotation without being subjected to a continuous deformation with too high a load during the operation of the rotational angle sensor unit, which could result in a destruction of and/or damage to the plastic spring. The angle between the plastic spring inner face and the base body outer face is, in particular, in a range between 8° and 10°, for example approximately 9°, in an unloaded state of the plastic spring. To establish the angle, the plastic spring inner face does not have to directly abut the base body outer face or extend away therefrom. Instead, the angle may result between two planes in which the plastic spring inner face and the base body outer face are situated. The plastic spring inner face, which is arranged at an angle in the range between 7° and 11° relative to the base body outer face, extends at least partially, in particular completely, over the intermediate section and/or spring head described above.

It is also possible that, in a rotational angle sensor unit according to the present invention, the plastic spring can have a connecting section, to which the plastic spring is connected to the base body in a materially bonded manner, and an end-side spring head with an end face, a height of the plastic spring being in a range between 10 mm and 14 mm from the connecting section to the end face. In trials within the scope of the present invention, this dimensioning also resulted in the desired flexibility in combination with the necessary stability. The height may be the shortest distance between an outer edge region of the connecting section and the end face. The outer edge region may be positioned in the same plane as an underside of the base body. The height preferably has a value in a range between 11 mm and 13 mm, for example 12 mm or 12.2 mm.

The plastic spring of a rotational angle sensor unit may have a connecting section, to which the plastic spring is connected to the base body in a materially bonded manner, an end-side spring head with an end face and an intermediate section between the connecting section and the spring head, the intermediate section tapering in a direction from the connecting section to the spring head. As already described above with reference to the entire plastic spring, a higher stability may be achieved thereby in the area of the intermediate section subjected to greater mechanical stress, while a material and weight saving may be achieved in the areas of the intermediate section subjected to less stress. On the whole, a good compromise may thus be achieved between as little material as possible and high stability. The tapering is to be viewed, in particular, with reference to the plastic spring inner face and the plastic spring outer face, which may run toward each other in a tapering manner in the direction of the spring head.

It is furthermore possible that, in a rotational angle sensor unit according to the present invention, the plastic spring can have an end face and two secondary sides, which define a width of the plastic spring, the width of at least one part of the plastic spring, in particular over the entire length and/or height of the plastic spring, is in a range between 2.5 mm and 3 mm. The desired flexibility with a sufficiently high stability may also be achieved with the aid of a dimensioning of this type. The width is preferably in a range between 2.6 mm and 2.9 mm, for example approximately 2.8 mm.

The use of PA66-GF15 as the material for the plastic spring has also been shown to be particularly advantageous, in particular, in interaction with the dimensioning described above. In other words, the plastic spring may include PA66-GF15 or be made up, in particular entirely, of PA66-GF15.

The housing and the anti-rotation device can be connected to each other as a single piece and/or monolithically. The housing and the anti-rotation device may be particularly easily provided thereby. The housing and the anti-rotation device may also include the same material or each be made up of the same material. In other words, the housing as well may include PA66-GF15 or be made up of this plastic. The housing and the anti-rotation device may together be or become designed as an integral component.

Also, an anti-rotation device is proposed for fastening to a housing of a rotational angle sensor unit as described in detail above. The anti-rotation device includes a base body and a plastic spring for securing the housing against a rotation of the housing relative to a stationary bearing body when the housing is positioned in a bearing volume of the bearing body with the aid of an anti-rotation device fastened thereto. The plastic spring has a plastic spring inner face facing the base body and a plastic spring outer face facing away from the base body, the plastic spring having a wall thickness in a range between 1.8 mm and 2.5 mm between the plastic spring inner face and the plastic spring outer face. The anti-rotation device according to the invention is thus associated with the same advantages as those described in detail with reference to the rotational angle sensor unit according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective representation of a rotational angle sensor unit according to an example;

FIG. 2 shows a cutaway side view of the rotational angle sensor unit illustrated in FIG. 1;

FIG. 3 shows a perspective representation of a housing for the rotational angle sensor unit according to an example;

FIG. 4 shows a cutaway side view of an anti-rotation device according to the invention;

FIG. 5 shows a side view of an anti-rotation device according to the present invention; and

FIG. 6 shows a characteristic curve diagram for explaining the technical property of an anti-rotation device according to the invention.

### DETAILED DESCRIPTION

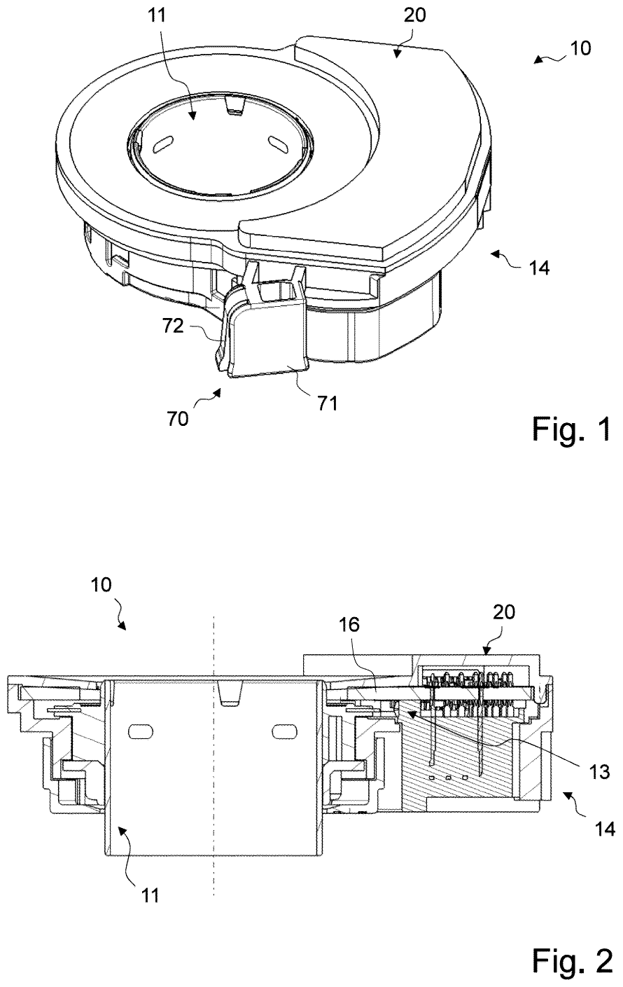

FIG. 1 shows a rotational angle sensor unit 10 for determining a rotational angle between a rotor 11 and a stator 13, illustrated in FIG. 2, of rotational angle sensor unit 10. Rotational angle sensor unit 10 includes a housing 14, which defines a housing volume, as well as rotor 11, which is rotatably supported in the housing volume. Rotational angle sensor unit 10 illustrated in FIG. 1 includes a cover 20, which is welded to housing 14. An anti-rotation device 70 is also fastened to housing 14. More specifically, anti-rotation device 70 is designed as an integral component of housing 14. In other words, housing 14 and anti-rotation device 70 are connected to each other as a single piece. Housing 14 and anti-rotation device 70 together are made up entirely of PA66-GF15. Anti-rotation device 70 does not have a metal spring. Anti-rotation device 70 includes a base body 71 and a one-piece plastic spring 72, exclusively as the spring, for securing against a rotation of housing 14 relative to a stationary bearing body when housing 14 is positioned in a bearing volume of the bearing body.

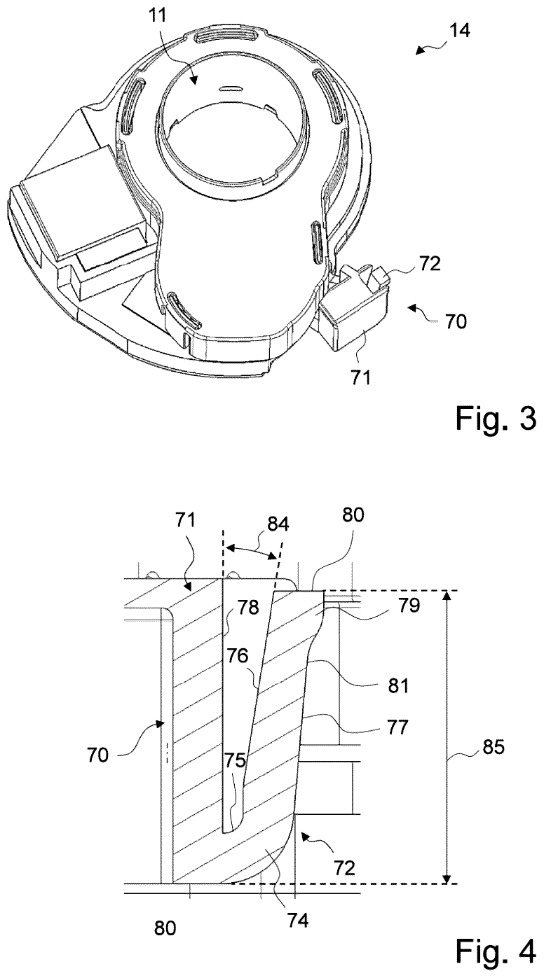

FIG. 2 shows a cutaway side view of rotational angle sensor unit 10 for illustrating customary components of a unit of this type, such as rotor 11, stator 13, and printed circuit board 16. Housing 14 and anti-rotation device 70 are illustrated from a further perspective in FIG. 3.

FIG. 4 shows anti-rotation device 70 in a cutaway and enlarged side view. As is apparent in FIG. 4, plastic spring 72 has a plastic spring inner face 76 facing base body 71 or pointing in the direction thereof, and a plastic spring outer face 77 facing away from base body 71 or pointing away therefrom. Base body 71 has a base body outer face 78 facing plastic spring inner face 76. Plastic spring 72 also has a connecting section 74, on which plastic spring 72 is connected to base body 71 in a materially bonded manner, and an end-side spring head 79 with an end face 80. In addition, plastic spring 72 has an intermediate section 81 between connecting section 74 and spring head 79, intermediate section 81 tapering in a direction or in its longitudinal extension from connecting section 74 to spring head 79. In a transitional section, or a point at which intermediate section 81 transitions into spring head 79 and intermediate section 81 has its smallest wall thickness, the wall thickness between plastic spring inner face 76 and plastic spring outer face 77 is approximately 1.8 mm. The wall thickness in the spring head is approximately 2 mm. The middle wall thickness is also 2 mm in connecting section 74 and at the widest point of intermediate section 81, i.e., in a region in which intermediate section 81 transitions into connecting section 74.

Connecting section 74 has an inner radius of curvature 75 of approximately 0.8 mm. In the illustrated unloaded state of plastic spring 72, an angle 84, which forms between plastic spring inner face 76, in particular in the region of intermediate section 81, and base body outer face 78, is approximately 9° in the illustrated example. A height 85 of plastic spring 72 from an underside or outer face of connecting section 74 to end face 80 is approximately 12 mm.

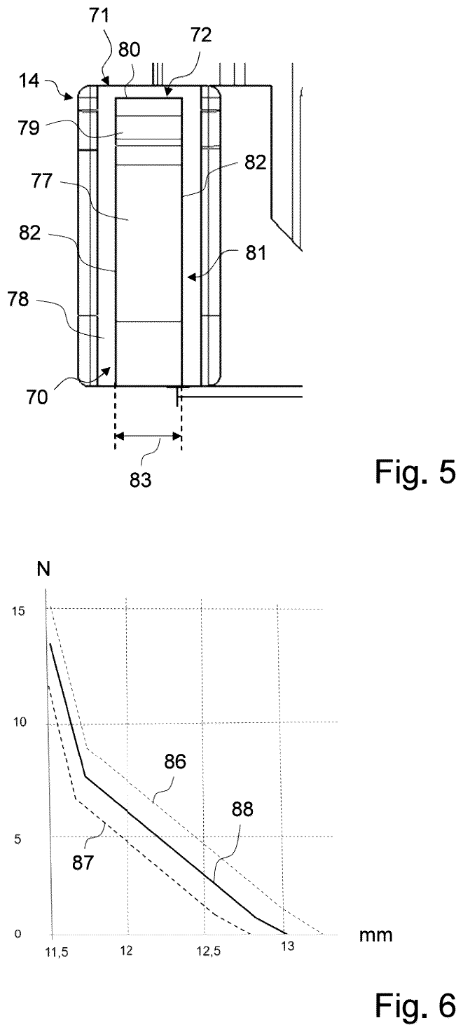

In FIG. 5, anti-rotation device 70 is illustrated in a further side view. In particular, two secondary sides 82 of plastic spring 72 are apparent in FIG. 5. Width 83 of plastic spring 72 from one secondary side 82 to the other secondary side 82 is approximately 2.8 mm in the illustrated example. The width of illustrated plastic spring 72 remains the same over its entire length or height 85. Secondary sides 82 run in parallel to each other.

FIG. 6 shows a characteristic curve diagram including different spring characteristic curves 86, 87, 88. Upper spring characteristic curve 86 shows an upper limit. Lower spring characteristic curve 87 shows a lower limit. Middle spring characteristic curve 88 shows a nominal profile which may be achieved with the aid of the illustrated anti-rotation device and the plastic spring contained therein without further aids, such as an additional metal spring.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A rotational angle sensor unit to determine a rotational angle between a rotor and a stator, the rotational angle sensor unit comprising:
a housing that defines a housing volume;
a rotor that is rotatably supported in the housing volume;
a stator;
a printed circuit board to which the at least one stator is fastened; and
an anti-rotation device comprising a base body and a plastic spring for securing against a rotation of the housing relative to a stationary bearing body when the housing is positioned in a bearing volume of the bearing body, the plastic spring having a plastic spring inner face facing the base body and a plastic spring outer face facing away from the base body, the plastic spring having a wall thickness in a range between 1.8 mm and 2.5 mm between the plastic spring inner face and the plastic spring outer face.

2. The rotational angle sensor unit according to claim 1, wherein the plastic spring is connected to the base body in a materially bonded manner in a connecting section and has an inner radius of curvature in a range between 0.5 mm and 1 mm in the connecting section.

3. The rotational angle sensor unit according to claim 1, wherein the base body has a base body outer face facing the plastic spring inner face, and wherein an angle between the plastic spring inner face and the base body outer face is in a range between 7° and 11° in an unloaded state of the plastic spring.

4. The rotational angle sensor unit according to claim 1, wherein the plastic spring has a connecting section, to which the plastic spring is connected to the base body in a materially bonded manner, and an end-side spring head with an end face, a height of the plastic spring being in a range between 10 mm and 14 mm from the connecting section to the end face.

5. The rotational angle sensor unit according to claim 1, wherein the plastic spring has a connecting section, to which the plastic spring is connected to the base body in a materially bonded manner, an end-side spring head with an end face and an intermediate section between the connecting section and the spring head, the intermediate section tapering in a direction from the connecting section to the spring head.

6. The rotational angle sensor unit according to claim 1, wherein the plastic spring has an end face and two secondary sides defining a width of the plastic spring, the width of at least one part of the plastic spring being in a range between 2.5 mm and 3 mm.

7. The rotational angle sensor unit according to claim 1, wherein the plastic spring includes PA66-GF15 or is made up of PA66-GF15.

8. The rotational angle sensor unit according to claim 1, wherein the housing and the anti-rotation device are connected to each other as a single piece and/or monolithically.

9. The rotational angle sensor unit according to claim 1, wherein the housing and the anti-rotation device include the same material or are each made up entirely of the same material.

10. An anti-rotation device for fastening to a housing of a rotational angle sensor unit according to claim 1, the anti-rotation device comprising:
a base body; and
a plastic spring to secure the housing against a rotation of the housing relative to a stationary bearing body when the housing is positioned in a bearing volume of the bearing body with the aid of an anti-rotation device fastened thereto, the plastic spring having a plastic spring inner face facing the base body and a plastic spring outer face facing away from the base body, and the plastic spring having a wall thickness in a range between 1.8 mm and 2.5 mm between the plastic spring inner face and the plastic spring outer face.
